(19) United States
(12) Patent Application Publication
(10) Pub. No.: US 2015/0256974 A1
(43) Pub. Date: Sep. 10, 2015

(54) PROXIMITY ESTIMATION METHOD AND APPARATUS USING ROUND TRIP TIME IN A WIRELESS COMMUNICATION SYSTEM AND METHOD AND APPARATUS FOR PROVIDING LOCATION BASED SERVICE USING SAME

(71) Applicant: Samsung Electronics Co., Ltd., Gyeonggi-do (KR)

(72) Inventors: Andrey ZOBENKO, Gyeonggi-do (KR); Soo-Yong KIM, Gyeonggi-do (KR); Jin-Yong CHUNG, Seoul (KR)

(73) Assignee: Samsung Electronics Co., Ltd.

(21) Appl. No.: 14/640,747

(22) Filed: Mar. 6, 2015

Related U.S. Application Data
(60) Provisional application No. 61/948,833, filed on Mar. 6, 2014.

(30) Foreign Application Priority Data
Nov. 12, 2014 (KR) 10-2014-0157057

(51) Int. Cl. H04W 4/02; G01S 5/02

(52) U.S. Cl. CPC H04W 4/023; H04W 4/021; G01S 5/0284

(57) ABSTRACT

A proximity estimation method and apparatus are provided for measuring a distance between devices in a wireless communication system. The method includes transmitting, by a first device, a first signal to a second device; receiving, by the first device, a second signal from the second device, in response to the first signal; and measuring, by the first device, a distance between the first device and the second device, based on a phase difference between the first signal and the second signal.

### PRIORITY

This application claims priority under 35 U.S.C. §119 to U.S. Provisional Patent Application Ser. No. 61/948,833, which was filed in the United States Patent and Trademark Office on Mar. 6, 2014 and to Korean Application Serial No. 10-2014-0157057, which was filed in the Korean Intellectual Property Office on Nov. 12, 2014, the entire content of each of which is incorporated herein by reference.

### BACKGROUND OF THE DISCLOSURE

1. Field of the Disclosure

The present disclosure relates generally to a method and an apparatus for estimating a location in a wireless communication system, and more particularly, to a method and an apparatus for estimating a proximity location, which can be used indoors.

2. Description of the Related Art

A key technology in the Internet-of-Things (IoT) and a Location Based Service (LBS) includes an Indoor Positioning System (IPS).

The IPS may be implemented by, for example, an Inertial Navigation System (INS) using Microelectromechanical System (MEMS) sensors, a fingerprinting method using received signal strength, and a Time-of-Arrival (TOA) scheme using access points (APs) (in contrast with a TOA scheme using satellite receivers in a Global Navigation Satellite System (GNSS)).

In consideration of power consumption by a terminal that uses a battery when the IPS is implemented, the power consumption should be minimized using simple, but still accurate, algorithms. However, there is a technical compromise between the power consumption of the terminal and the precision of the location estimation.

To provide an effective LBS, such as geofencing in crowded shopping centers, information for location estimation in the IPS should have a location estimation accuracy under a few meters. However, due to severe multipath environments, the complexities of radio propagation, and limited power usage in a terminal, it is difficult to provide an accurate LBS in the wireless communication system.

Further, to improve the TOA estimation accuracy of the terminal in the wireless communication system, measurements are performed at very short time intervals (e.g., tens of nanoseconds). For this measurement, high frequency in delay-measurement modules are provided in the terminal, disadvantageously increasing the power consumption and development complexity of the terminal.

### SUMMARY

Accordingly, the present disclosure has been made to address the above-described problems and disadvantages and to provide at least the advantages described below.

An aspect of the present disclosure is to provide a proximity estimating method and apparatus for efficiently estimating a distance between devices located indoors in a wireless communication system.

Another aspect of the present disclosure is to provide a method and an apparatus for efficiently providing a location based service to a device located indoors in a wireless communication system.

In accordance with an aspect of the present disclosure, a proximity estimation method is provided for measuring a distance between devices in a wireless communication system. The proximity estimation method includes transmitting, by a first device, a first signal to a second device; receiving, by the first device, a second signal from the second device, in response to the first signal; and measuring, by the first device, a distance between the first device and the second device, based on a phase difference between the first signal and the second signal.

In accordance with another aspect of the present disclosure, a first device is provided for measuring a distance in a wireless communication system. The first device includes a transceiver; and a controller that controls the transceiver to transmit a first signal to a second device, controls the transceiver to receive a second signal from the second device, in response to the first signal, and measures a distance between the first device and the second device, based on a phase difference between the first signal and the second signal.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 illustrates a proximity estimation scheme for estimating a distance between devices in a wireless communication system according to an embodiment of the present disclosure;

FIGS. 2A to 2C illustrate navigation signal characteristics according to an embodiment of the present disclosure;

FIG. 3 illustrates a process of generating a response signal in a second device according to an embodiment of the present disclosure;

FIG. 4 illustrates a delay compensation operation performed in a second device according to an embodiment of the present disclosure;

FIG. 5 illustrates a proximity estimation method performed in a first device according to an embodiment of the present disclosure;

FIG. 6 is a flowchart illustrating a method of measuring a distance between devices in a wireless communication system according to an embodiment of the present disclosure; and

FIG. 7 is a block diagram illustrating a device in a wireless communication system according to an embodiment of the present disclosure.

### DETAILED DESCRIPTION OF EMBODIMENTS OF THE DISCLOSURE

Various embodiments of the present disclosure will be described with reference to the accompanying drawings. In the following description of the embodiments of the present disclosure, detailed descriptions of known functions or configurations incorporated herein will be omitted to avoid obscuring the subject matter of the present disclosure in unnecessary detail.

A location estimation or distance measurement scheme using an existing satellite signal cannot effectively be used indoors because satellite signal strength often reaches a zero level. Accordingly, an aspect of the present disclosure is to provide a proximity estimation scheme for measuring a distance between devices, which transmit and receive wireless signals for a location based service in an indoor environment. For example, a wireless communication system that utilizes a proximity estimation scheme according to an embodiment of the present disclosure may include a Wi-Fi system, a Bluetooth system, or an Institute of Electrical and Electronics Engineers (IEEE) 802.x based wireless communication system.

In addition, the proximity estimation scheme may use a low power design, which uses frequencies lower than a GHz range by employing a frequency down-conversion, e.g., by a mixer in a device, in order to reduce power consumption in the device. Therefore, a proximity estimation scheme in accordance with an embodiment of the present disclosure may be applied to mobile devices, such as various wearable products and IoT products.

Further, when the proximity estimation scheme is applied to an IEEE 802.11 based wireless communication system, specific circuit development is not required during implementation of a device using Wi-Fi, and, for example, a conventional Wi-Fi Quadrature Amplitude Modulation (QAM) modulator may be easily implemented.

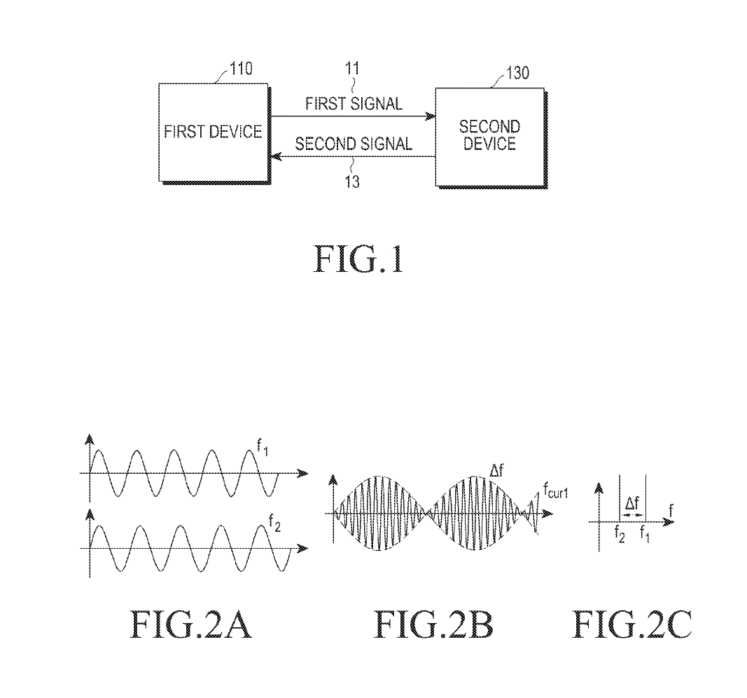

FIG. 1 illustrates a proximity estimation scheme for estimating a distance between devices in a wireless communication system according to an embodiment of the present disclosure.

Referring to FIG. 1, when a distance between a first device 110 and a second device 130 is measured, the first device 110 generates and transmits a first signal 11 to the second device 130. In response, the second device 130 generates and transmits a second signal 13.

Specifically, the first device 110 transmits the first signal 11 and then estimates a distance between the first device 110 and the second device 130 using a phase difference between the first and second signals 11 and 13, based on a round trip time until receiving the second signal 13. The distance measurement may be performed in areas, which have a proximity distance within a few meters to tens of meters between the first and second devices 110 and 130, such as shopping centers or customer-premises.

When proximity estimation is performed using a propagation delay generated by a round-trip progress of the signals 11 and 13 transmitted and received between the first and second devices 110 and 130, an accuracy of the proximity estimation can be further improved.

For example, the first and second devices 110 and 130 may be various wireless devices including wireless communication modules such as a portable terminal, a tablet Personal Computer (PC), a laptop, a relay station, a base station, an Access Point (AP), etc. As illustrated in the example of FIG. 1, the first device 110 is a wireless device of a user who desires to measure a distance and the second device 130, e.g., a relay station, an AP, or a base station, is used as a reference point for measuring the distance.

In addition, the first and second signals 11 and 13 may use a separate navigation signal prepared for a distance measurement. For example, the navigation signal may include a synchronization field, a Physical Layer Convergence Protocol (PLCP) field, a data field, and a Cyclic Redundancy Check (CRC) field when being applied to an IEEE 802.11 standard. The data field is located in a physical layer and remaining fields are included in a transmission layer and are used in a payload. Further, in the IPS, the data field may replace an Orthogonal Frequency Division Multiplexing (OFDM) format with a format of an orthogonal modulation navigation signal.

FIGS. 2A to 2C illustrate navigation signal characteristics according to an embodiment of the present disclosure. For example, the navigation signal may be a sounding signal.

Referring to FIGS. 2A to 2C, the first device 110 generates a navigation signal having an envelope as illustrated in FIG. 2B by combining harmonic signals 21 and 22, as illustrated in FIG. 2A. The two harmonic signals 21 and 22 have different frequencies f₁ and f₂, respectively, and have identical amplitudes.

Further, as illustrated in FIG. 2C, a difference of the frequencies f₁ and f₂ is illustrated as Δf. Herein, the amplitude identical to the different frequencies f₁ and f₂ generates a beating of the envelope in a navigation signal of a first frequency f_{cur1}. For example, a navigation signal, which is transmitted by the second device 130 as a response signal to the first device 110 as illustrated in FIG. 1, may be generated using the scheme illustrated in the FIGS. 2A to 2C.

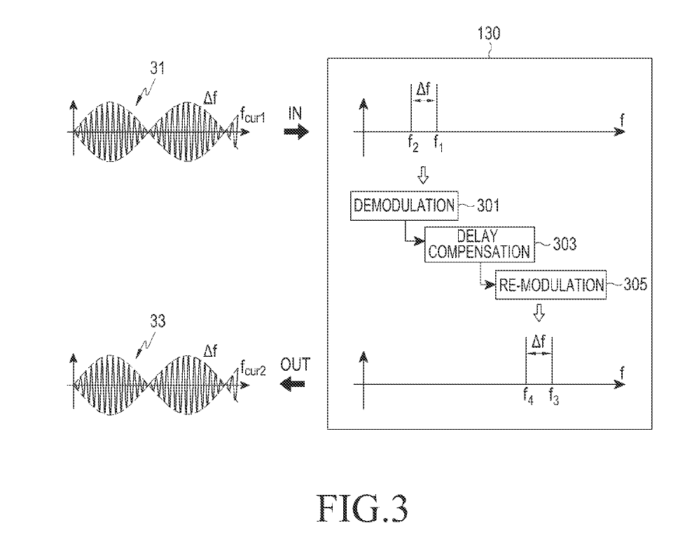

FIG. 3 illustrates a process of generating a response signal in a second device according to an embodiment of the present disclosure.

Referring to FIG. 3, reference numerals 31 and 33 in FIG. 3 indicate a navigation signal (hereinafter, a first signal) transmitted by the first device 110 and a navigation signal (hereinafter, a second signal) transmitted as a response signal by the second device 130, respectively. Herein, it is assumed that each of the first and second signals 31 and is transmitted with a different frequency. Further, the first signal 31 has a first frequency f_{cur1} and the second signal 33 has a second frequency f_{cur2}.

Most devices using a Wireless Local Area Network (WLAN) follow the IEEE 802.11 standard, which uses Time Division Duplexing (TDD). For example, in order to implement the features of the IEEE 802.11n/ac, Radio Frequency (RF) front end Integrated Circuits (ICs) may have a dual band (e.g., 2.4 GHz and 5 GHz; bandwidths have 20 MHz to 160 MHz for each protocol).

For example, when following the IEEE 802.11 standard, the first signal 31 may be transmitted with a 2.4 GHz carrier frequency and the second signal 33 may be transmitted with a 5 GHz carrier frequency. The reverse is also possible. In FIG. 3, it is assumed that the first and second signals 31 and 33 are transmitted through the different frequency bands; however, the first and second signals 31 and 33 may be transmitted through an identical frequency band.

Based on structures of a WLAN following the IEEE 802.11 standard, a sine synthesizer (not shown) included in the first device 110 first generates the 2.4 GHz carrier signal. The generated carrier signal is input to a quadrature modulator (not shown) in the first device 110 together with a sine signal having, for example, 1-20 MHz frequencies to be radio frequency (RF) modulated, and is amplified through an amplifier to be transmitted as the first signal 31.

The second device 130 demodulates (as indicated by reference numeral 301) the received first signal 31 and then re-modulates (as indicated by reference numeral 305) the demodulated signal into the second signal 33. In this event, a re-modulated frequency band may use 5 GHz. A phase of the envelope of the first signal 31 received by the second device 130 should be identical to a phase of the envelope of the second signal 33 transmitted by the second device 130. That is, in the example of FIG. 3, a phase of the envelope of the first signal 31 transmitted with a 5 GHz carrier should be identical to a phase of the envelope of the second signal 33 transmitted with a 2.4 GHz carrier.

However, in fact, some delay and phase shift may occur in a signal processing procedure in the second device 130. The second device 13 may perform delay compensation 303 for compensating for the delay and the phase shift. The delay compensation 303 may be selectively performed.

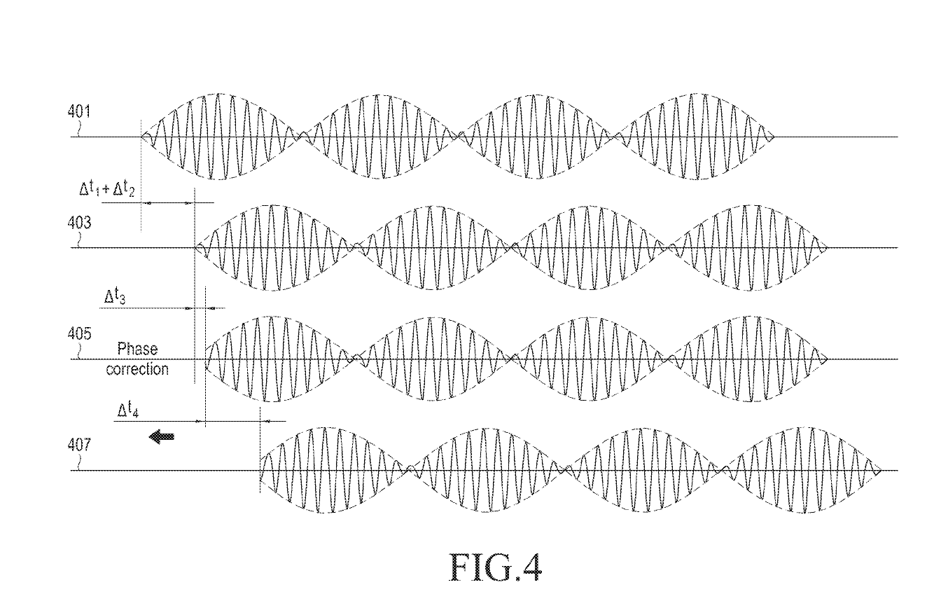

FIG. 4 illustrates a delay compensation operation performed in a second device according to an embodiment of the present disclosure.

Referring to FIG. 4, reference numerals 401 and 403 indicate a delay that occurs when generating and transmitting a first signal 11, i.e., a sum (Δt₁+Δt₂) of a delay (Δt₁), which occurs in a generation procedure of the first signal 11 in the first device 110, and a delay (Δt₂), which occurs when the first signal 11 is transmitted through a wireless network. Reference number 405 indicates a delay (Δt₃), which occurs in a signal processing procedure in the second device 130. Further, reference number 407 indicates a delay (Δt₄), which occurs when the second signal 13 is transmitted through the wireless network. A delay compensation operation performed in the second device 130 is for compensating for the delay (Δt₃).

The second device 130 calculates the phase of the first signal 11 and subtracts a phase delay, which the first signal 11 uses to be passed through the second device 130, from the calculated phase. Thereafter, the second device 130 synthesizes an envelope signal in which a phase is compensated for through a quadrature modulation.

The second signal 13 may compensate for the delay (Δt₃) by the delay compensation operation in all phase delays, and thus, the phase delay of the second signal 13 received by the first device 110 becomes dependent only on a distance between the first device 110 and the second device 130.

The second device 13 allows the second signal 13 to be located with a new carrier (e.g., 2.4 GHz carrier) through the re-modulation 305. Again, it is assumed that two harmonic signals used to generate the second signal 13 have different frequencies f₃ and f₄, respectively, and have identical amplitudes.

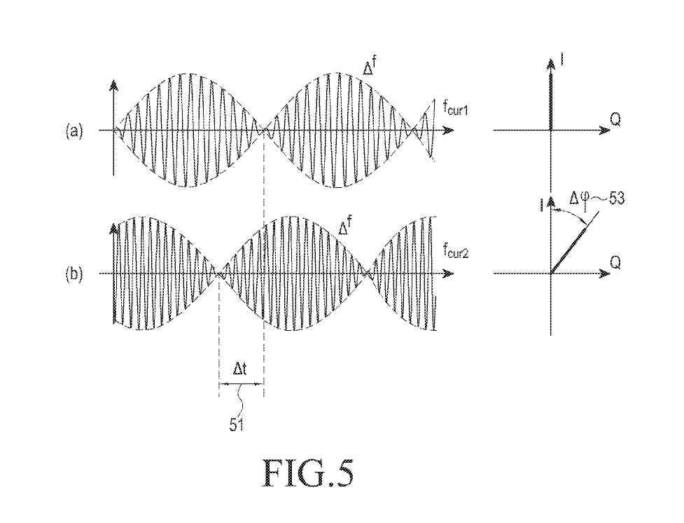

FIG. 5 illustrates a proximity estimation method performed in a first device according to an embodiment of the present disclosure.

Referring to FIG. 5, the first device 110 compares, e.g., using a phase detector, a phase of a first signal (a) and a phase of a second signal (b) delayed and received (as indicated by reference numeral 51) depending on a distance between a first device 110 and a second device 130. Thereafter, the first device 110 linearly converts a phase difference 53 between the two phases into a distance between the first device 110 and the second device 130.

In a proximity estimation according to an embodiment of the present disclosure, a coverage range R depends on a cycle of a harmonic frequency and may be expressed as shown in Equation (1).

R=c/fₕ (1)

In Equation (1), c is the speed of light and fₕ is a harmonic frequency (i.e., an envelope frequency in the quadrature modulation). For example, using the envelope frequency with 20 MHz, R will be approximately 15 m, and using the envelope frequency with 10 MHz, R will be approximately 30 m.

Practically, in an indoor environment, the coverage range R is sufficient to identify a location of a device.

Because the proximity measurement measures a distance using a periodic signal such as the navigation signal, synchronization between the devices is not required. However, multi-solutions to calculate a Round Trip Time (RTT) may exist because of the periodicity of the modulated signals and multipath propagation. By considering this, irregular values can be discarded, based on the coverage range of envelope frequencies. Moreover, attenuated multipath signals are distinguished from the directly transmitted signals under typical indoor conditions such as shopping centers or customer-premises. Nevertheless, to avoid confusion caused by multi-solutions, it is possible to use different, non-aliquot frequencies of the carriers. For example, the first signal may be modulated into a signal having 20 MHz and the second signal may be modulated into a signal having 18.7 MHz. If the first and second devices 110 and 130 know this information, a phase detector of the first device may find the exact solution with the coverage range.

In a phase detection operation of the first device 110, phase detection by I-Q modulation is performed and a phase difference is measured by the RTT. The first device 110 transmits the modulated first signal 11 and stores an envelope signal through two quantizers of each I-Q branch. In addition, the first device 110 receives and demodulates the second signal 13 transmitted with a different carrier frequency, and then compares the phase of the first signal 11 with the phase of the second signal 13 using a phase detector to estimate the distance between the first device 110 and the second device 130, based on the phase difference. The phase detector is based on a matched filer, and the distance may be calculated from an angle (i.e., phase difference) between vectors of the first signal and the second signal in an I-Q surface as shown in an example of FIG. 5.

Using PIQ as the phase difference, the distance may be calculated as shown in Equation (2).

$$D = \frac{c \cdot {p}_{IQ}}{360 {f}_{h}} \qquad ( 2 )$$

In Equation (2), c is the speed of light and fₕ is the harmonic frequency.

As described above, the first device 110 may increase a positioning accuracy using the RTT and perform efficient proximity estimation to reduce power consumption using the quadrature modulation.

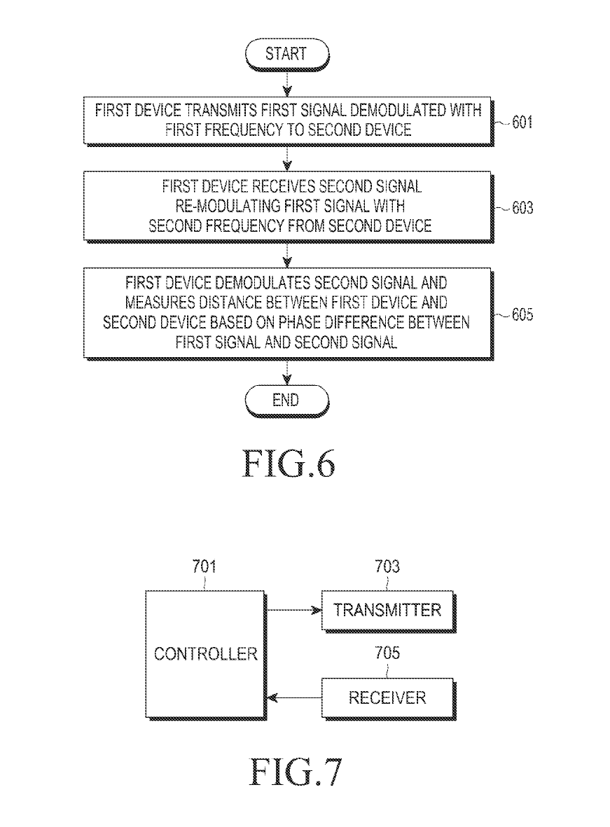

FIG. 6 is a flowchart illustrating a proximity estimation method for measuring a distance between devices in a wireless communication system according to an embodiment of the present disclosure.

Referring to FIG. 6, a first device 110 transmits, to a second device 130, a first signal 11 having a first frequency in step 601. The first device 110 may use a quadrature modulation of a relatively low frequency in order to reduce power consumption, when the first signal 11 is transmitted.

In step 603, the first device 110 receives, from the second device 130, a second signal 13 having a second frequency. The second device 130 may perform delay compensation, after demodulating the first signal 11, and then perform re-modulation to the second signal 13.

In step 605, the first device 110 demodulates the second signal 13 received from the second device 130 and measures a distance between the first device 110 and the second device 130, based on a phase difference between the first signal 11 and the second signal 13.

FIG. 7 is a block diagram illustrating a device in a wireless communication system according to an embodiment of the present disclosure. Specifically, FIG. 7 illustrates a configuration which is applicable to the first device 110 and/or the second device 130.

Referring to FIG. 7, a device includes a controller 701 that controls overall operations of the device. Specifically, the controller controls a proximity estimation operation according to the schemes illustrated in FIGS. 1 to 6. Further, the controller 701 may, for the proximity estimation operation, selectively include an envelope detection device, a phase detection device, etc., according to a configuration of the device.

Further, the device includes a transmitter 703 and a receiver 705. The transmitter 703 includes a modulator and an amplifier as a communication module for transmitting a signal through a wireless network. The receiver 705 includes a demodulator and an amplifier as a communication module for receiving a signal from the wireless network.

Although the transmitter 703 and the receiver 705 are illustrated as separate components, they may be embodied as a single transceiver. Further, the communication interface may also include a frequency down-converting mixer in order to reduce power consumption.

In accordance with an embodiment of the present disclosure, a possible measurement distance and an accuracy of the proximity estimation may vary depending on the envelope frequency.

A location based service using the proximity estimation scheme may be applied to, for example, shopping centers in a building, department stores, indoor playgrounds, amusement parks, apartments, apartment-type factories, customer-premises, etc.

For example, a user's mobile phone may operate as a first device because an application is installed to provide the location based service, and repeaters, APs, or base stations, which are installed for each certain area in the shopping centers, operate as a second device. An application installed in the first device displays a distance measured according to the proximity scheme through a screen provided through the application. In addition, a point where the second device is located may be expressed as stores and facilities, which a user easily recognizes in the shopping centers, and thus, may provide various location based services to the user.

Further, the second device may be implemented by receiving distance information measured from the first device according to an operation of the application to provide location based advertisement information to at least one first device located within a distance determined by the second device.

As another embodiment, a user's mobile phone can operate as the second device and repeaters, APs, or base stations which are installed at each certain area in the shopping centers can operate as the first device. In this event, the first device may provide advertisement information, etc., to at least one second device measured as being located within a certain distance of the second devices. When unique identification information of the second device has been stored in the first device, a user location of the second device may be notified of another user related to a user of the second device, e.g., being utilized to find a missing child.

According to an embodiment of the present disclosure, positioning accuracy can be about 1 m and power usage can be reduced in the device by using the RTT measurement and the proximity estimation using the quadrature modulation of a frequency (e.g., less than GHz), which is relatively lower than a carrier frequency.

Further, because existing configurations for signal processing in the devices can be re-used, implementation of the device is simple.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. A method of measuring a distance between devices in a wireless communication system, the method comprising:
transmitting, by a first device, a first signal to a second device;
receiving, by the first device, a second signal from the second device, in response to the first signal; and
measuring, by the first device, a distance between the first device and the second device, based on a phase difference between the first signal and the second signal.

2. The method of claim 1, wherein transmitting the first signal comprises orthogonal modulating the first signal to a frequency that is lower than a carrier.

3. The method of claim 1, wherein the first signal and the second signal have different frequencies.

4. The method of claim 1, wherein the second device generates the second signal by:
demodulating the first signal; and
re-modulating a signal having a frequency that is different from a frequency of the first signal after the first signal is demodulated.

5. The method of claim 4, further comprising applying a delay compensation by a signal processing delay in the second device, after the first signal is demodulated.

6. The method of claim 1, wherein the first device and the second device are located indoors.

7. The method of claim 1, wherein the first signal and the second signal are generated using a plurality of harmonic signals having different frequencies and identical amplitudes.

8. The method of claim 1, wherein measuring the distance comprises:
calculating the phase difference by comparing a first phase of the first signal and a second phase of the second signal; and
measuring the distance using the phase difference and an envelope frequency used to transmit the first signal.

9. A first device for measuring a distance in a wireless communication system, the first device comprising:
a transceiver; and
a controller that controls the transceiver to transmit a first signal to a second device, controls the transceiver to receive a second signal from the second device, in response to the first signal, and measures a distance between the first device and the second device, based on a phase difference between the first signal and the second signal.

10. The first device of claim 9, wherein the controller orthogonal modulates the first signal to a frequency that is lower than a carrier frequency.

11. The first device of claim 9, wherein the first signal and the second signal have different frequencies.

12. The first device of claim 9, wherein the first device and the second device are located indoors.

13. The first device of claim 9, wherein the first signal and the second signal are generated using a plurality of harmonic signals having different frequencies and identical amplitudes.

14. The first device of claim 9, wherein the controller calculates the phase difference by comparing a first phase of the first signal and a second phase of the second signal, and measures the distance using the phase difference and an envelope frequency used to transmit the first signal.
